(19) United States
(12) Patent Application Publication
(10) Pub. No.: US 2026/0159314 A1
(43) Pub. Date: Jun. 11, 2026

(54) CONTAMINANT DETECTION IN REFUSE CONTAINERS

(71) Applicant: Oshkosh Corporation, Oshkosh, WI (US)

(72) Inventors: Jerrod Kappers, Oshkosh, WI (US); Vince Andrada, Oshkosh, WI (US); Joel Komurka, Oshkosh, WI (US); Joseph Wigle, Oshkosh, WI (US); Vince Schad, Oshkosh, WI (US); Brian Brost, Oshkosh, WI (US)

(73) Assignee: Oshkosh Corporation, Oshkosh, WI (US)

(21) Appl. No.: 19/413,903

(22) Filed: Dec. 9, 2025

Related U.S. Application Data
(60) Provisional application No. 63/730,165, filed on Dec. 10, 2024.

(51) Int. Cl. B65F 3/14; B65F 3/04

(52) U.S. Cl. CPC B65F 3/14; B65F 3/041; B65F 2003/146

(57) ABSTRACT

A refuse vehicle includes a chassis, and a body coupled to the chassis. The refuse vehicle further includes a grabber assembly coupled to the body, where the grabber assembly is configured to engage a refuse container, and a contaminant detection system. The contaminant detection system includes a detection device coupled to the grabber assembly, where the detection device configured to create scan data of refuse material contained within the refuse container, and a controller communicably coupled to the detection device. The controller includes one or more processors communicably coupled to a memory, with the memory storing identifiers corresponding to a presence of a contaminant within the refuse material. The controller is configured to generate a scan of the refuse material based on the scan data, and determine, based on the scan data and the identifiers, the presence of a contaminant within the refuse material.

### CROSS-REFERENCE TO RELATED APPLICATIONS

This application claims priority to and the benefit of U.S. Provisional Patent Application No. 63/730,165, filed Dec. 10, 2024, the entire contents of which are hereby incorporated by reference herein.

### BACKGROUND

The present invention relates generally to the field of refuse vehicles and systems for analyzing refuse materials received by the refuse vehicle.

### SUMMARY

One exemplary embodiment of the present disclosure relates to a refuse vehicle including a chassis, and a body coupled to the chassis. The refuse vehicle further includes a grabber assembly coupled to the body, where the grabber assembly is configured to engage a refuse container, and a contaminant detection system. The contaminant detection system includes a detection device coupled to the grabber assembly, where the detection device configured to create scan data of refuse material contained within the refuse container, and a controller communicably coupled to the detection device. The controller includes one or more processors communicably coupled to a memory, with the memory storing identifiers corresponding to a presence of a contaminant within the refuse material. The controller is configured to generate a scan of the refuse material based on the scan data, and determine, based on the scan data and the identifiers, the presence of a contaminant within the refuse material.

In some embodiments, the contaminant detection system further includes an agitator, where the agitator is configured to agitate the refuse material contained within the refuse container during operation of the detection device. In some embodiments, the controller is further configured to generate a first scan of the refuse material before operation of the agitator, generate a second scan of the refuse material after operation of the agitator, and determine the presence of the contaminant by comparing the first scan and the second scan.

In some embodiments, the detection device includes an electromagnetic scanning device. In some embodiments, the electromagnetic scanning device includes a first sensor positioned on a first grabber arm of the grabber assembly and a second sensor positioned on a second grabber arm of the grabber assembly that is configured to receive signals from the first sensor. In some embodiments, the scan generated by the controller is an electromagnetic image. The identifiers corresponding to the presence of the contaminant within the refuse material include an electromagnetic signal associated with a material of the contaminant.

In some embodiments, the detection device is a first detection device, and the contaminant detection system further includes a second detection device. In some embodiments, the second detection device includes a thermal imaging device. In some embodiments, the controller is configured to generate a first scan of the refuse material based on scan data from the first detection device; determine, based on the scan data and the identifiers, an abnormality within the refuse material; generate a second scan of the refuse material based on scan data from the second detection device; and determine, based on the second scan and the identifiers, the presence of the contaminant within the refuse material.

In some embodiments, the refuse vehicle further includes a power source and a power disconnect, where the detection device is selectively coupled to the power source via the power disconnect. In some embodiments, the controller is configured to actuate the power disconnect to electrically disconnect the detection device from the power source when the detection device is not creating scan data of the refuse material.

Another embodiment relates to a refuse vehicle including a chassis, a body coupled to the chassis, and a grabber assembly coupled to the body, where the grabber assembly is configured to engage a refuse container. The refuse vehicle further includes a contaminant detection system including a detection device coupled to the grabber assembly, where the detection device is configured to generate sensor data indicative of a presence of a contaminant within refuse material contained within the refuse container; and a controller communicably coupled to the detection device, where the controller is configured to generate a notification responsive to sensor data indicating the presence of a contaminant in the refuse material.

In some embodiments, the controller is further configured to transmit the notification to a customer corresponding with the refuse container including the contaminant, based on detecting the presence of the contaminant.

In some embodiments, the detection device includes an electromagnetic imaging device. The controller is configured to receive electromagnetic scan data of the refuse material from the electromagnetic imaging device; generate an electromagnetic image of the refuse material based on the electromagnetic scan data; and determine the presence of a contaminant within the refuse material, based on the electromagnetic image and identifiers stored within a memory of the controller, where the identifiers include an electromagnetic signal corresponding to a material of the contaminant within the refuse material.

In some embodiments, the detection device includes a thermal imaging device. The controller is configured to receive thermal scan data of the refuse material from the thermal imaging device; generate a thermal image of the refuse material based on the thermal scan data; and determine the presence of the contaminant within the refuse material, based on the thermal image and identifiers stored within a memory of the controller, where the identifiers include a thermal signature corresponding to a material of the contaminant within the refuse material.

In some embodiments, the contaminant detection system further includes an agitator configured to agitate the refuse material within the refuse container. In some embodiments, the controller is configured to generate a first thermal image of the refuse material based on a first thermal scan data from the thermal imaging device; operate the agitator to agitate the refuse material within the refuse container; generate a second thermal image of the refuse material based on a second thermal scan data from the thermal imaging device, where the second thermal scan data is received from the thermal imaging device after agitation of the refuse material; and determine the presence of the contaminant within the refuse material, based on (i) comparing the first thermal image to the second thermal image and (ii) identifiers stored within a memory of the controller, where the identifiers include a change in thermal signature corresponding to a material of the contaminant within the refuse material after agitation.

In some embodiments, the detection device is a metal detector configured to detect a trigger element corresponding to the contaminant.

Another embodiment relates to a refuse vehicle including a chassis, a body coupled to the chassis, a grabber assembly coupled to the body, where the grabber assembly is configured to engage a refuse container, and a contaminant detection system. The contaminant detection system includes a detection device coupled to the grabber assembly, where the detection device is configured to generate scan data indicative of refuse material contained within the refuse container, an agitator coupled to the grabber assembly, where the agitator configured to agitate the refuse material within the refuse container; and a controller communicably coupled to the detection device. The controller includes one or more processors communicably coupled to a memory, where the memory stores identifiers corresponding to a presence of a contaminant within the refuse material. The controller is configured to control the agitator to agitate the refuse material, generate a scan of the refuse material based on the scan data, and determine, based on the scan data and the identifiers, the presence of a contaminant within the refuse material.

In some embodiments, the detection device is a thermal camera, where the agitator is configured to heat the refuse material. The identifiers include a thermal signature corresponding to a material of the contaminant within the refuse material.

The summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system that may be used by any of the refuse vehicles of FIGS. 1-3, according to an exemplary embodiment;

FIG. 5 is a diagram illustrating a collection route for autonomous transport and collection by a refuse vehicle, according to an exemplary embodiment;

FIG. 6 is a front perspective view of a refuse vehicle that includes a contaminant detection system having a first contaminant sensor arrangement, according to an exemplary embodiment;

FIG. 7 is a front perspective view of a refuse vehicle that includes a contaminant detection system having a second contaminant sensor arrangement, according to an exemplary embodiment;

FIG. 8 is top view of a grabber assembly of a refuse vehicle that includes a contaminant detection system, according to an exemplary embodiment;

FIG. 9 is a front view of a refuse vehicle that includes a contaminant detection system having a third contaminant sensor arrangement, according to an exemplary embodiment; and

FIG. 10 is front view of a refuse vehicle that includes a contaminant detection system having a fourth contaminant sensor arrangement, according to an exemplary embodiment.

FIG. 11 is a flowchart of a method to detect a contaminant within refuse material, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Refuse vehicles (e.g., garbage trucks, waste collection trucks, sanitation trucks, etc.) are vehicles configured to collect, process, and transport refuse. Hazardous articles or waste contaminants, such as batteries (e.g., lithium-ion batteries) are often disposed of with other types of refuse materials instead of being handled properly. When these contaminants are inadvertently collected and processed by a refuse vehicle not configured to do so, dangerous conditions can arise. For example, inadvertently compacting a lithium-ion battery intermixed with a quantity of refuse may cause a fire that is difficult to extinguish, and/or can ignite other materials that have been collected by the refuse vehicle, such as during waste compaction, transfer, and/or unloading operations.

Referring generally to the FIGURES, a refuse vehicle with a contaminant detection system for identifying hazardous and non-hazardous waste contaminants (e.g., batteries, abnormal and/or foreign materials, and/or materials of different types) is shown, according to various exemplary embodiments. The contaminant detection system includes one or more sensors configured to identify the presence of contaminants (e.g., batteries, abnormal and/or foreign materials, and/or materials of different types) located within a waste receptacle or other container before and/or during lift/grabber operations used to deposit the refuse material within the refuse vehicle.

According to an exemplary embodiment, the refuse vehicle includes a chassis, a body coupled to the chassis and a lift assembly coupled to the body, where the lift assembly includes a grabber assembly for engaging a refuse container. The refuse vehicle further includes a contaminant detection system. The contaminant detection system includes a detection device coupled to the lift assembly. The detection device is configured to generate sensor data indicative a contaminant contained within the refuse container. The refuse vehicle further includes a controller communicably coupled to the detection device. The controller is configured to generate a scan of the refuse material based on the sensor data and determine, from the scan, the presence of the contaminant within the refuse material. Such an arrangement can, beneficially, provide useful data regarding the presence of foreign and/or hazardous objects and/or other contaminants within the refuse material before entering an onboard refuse container, which can reduce the risk of damage to onboard systems and components (e.g., due to the flammability of the contaminant, chemical contamination, etc.).

Refuse material may include all kinds of objects; however, not every object can be collected using regular refuse collection techniques, nor can every object be safely collected with bulk garbage or other refuse material. These objects may be referred to as contaminants. For example, contaminants such as batteries may be unsafe to collect by conventional refuse collection methods, and can cause fires in refuse vehicles or at a transfer station if handled improperly. Further, by the time refuse reaches the transfer station, not only could a fire have occurred in the refuse vehicle, but the volume of refuse collected may be too large to analyze for contaminants. Detecting the presence of a contaminant within refuse contained in a refuse container allows the refuse to be safely collected and the contaminant to be removed from the refuse and properly disposed of in advance of compaction of the refuse material within the refuse vehicle and/or transfer operations.

### Refuse Vehicle

### Front-Loading Configuration

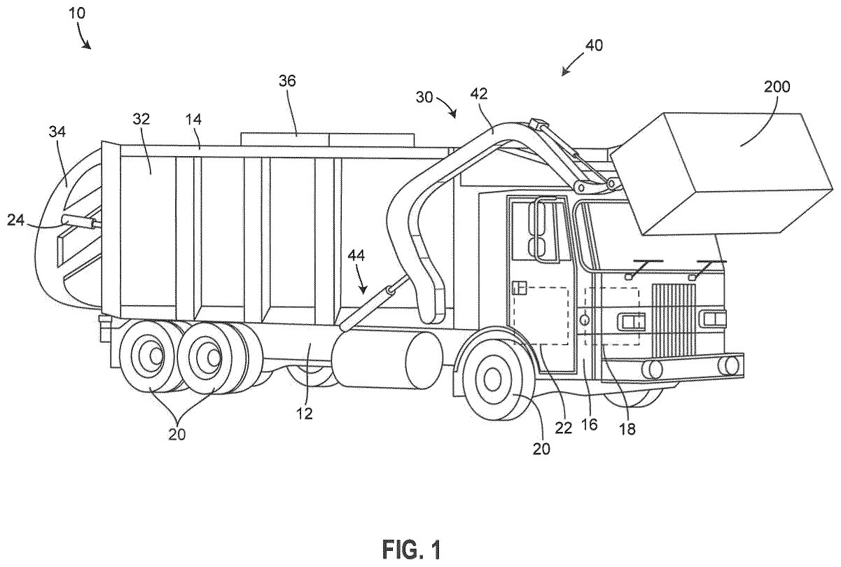

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the refuse container 200 as described in greater detail in U.S. application Ser. No. 17/558,183, filed Dec. 12, 2021, the entire disclosure of which is incorporated by reference herein.

### Rear-Loading Configuration

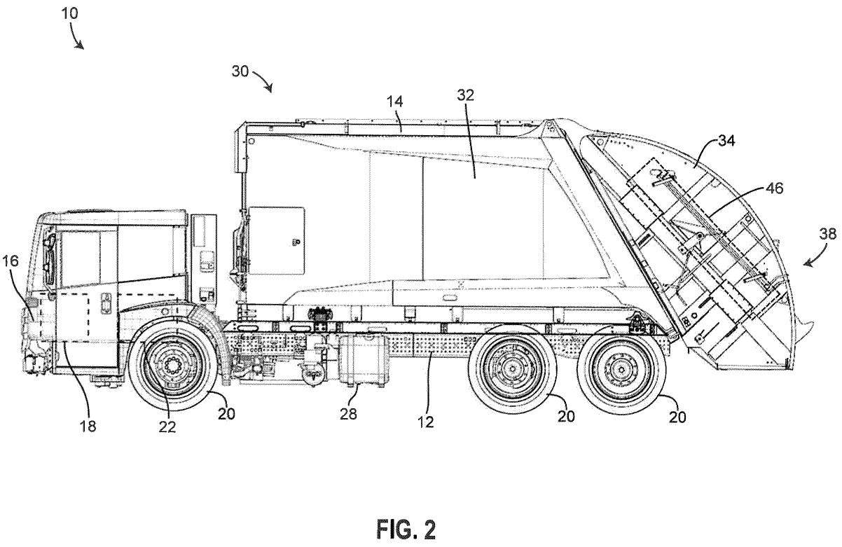

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

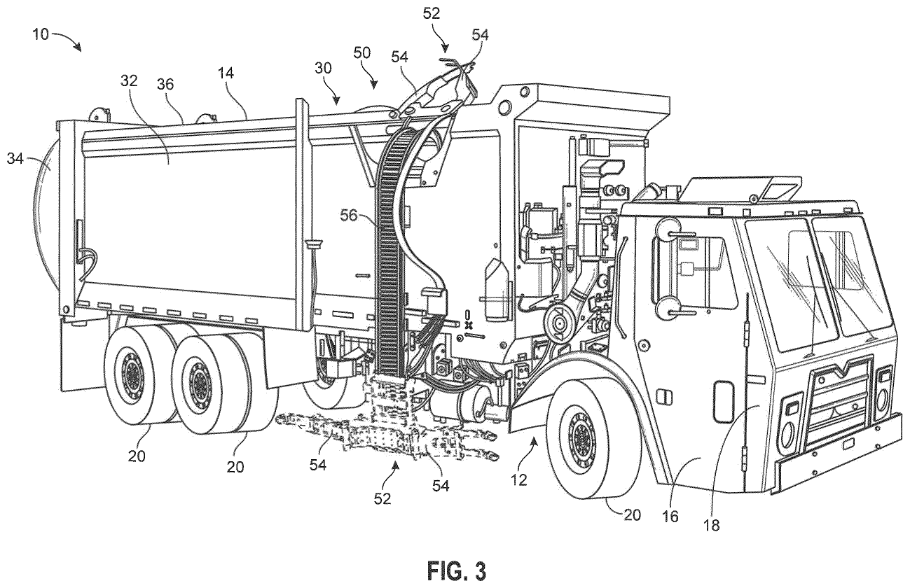

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

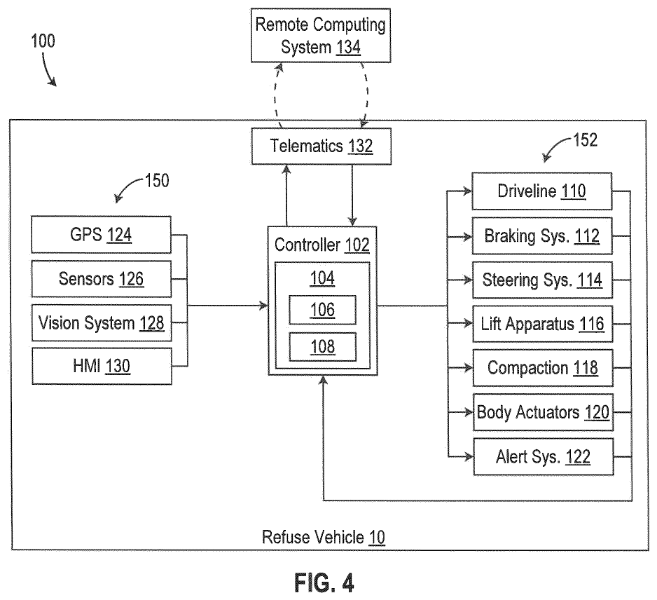

Referring to FIG. 4, the refuse vehicle 10 may include a control system 100 that is configured to facilitate operation of the refuse vehicle 10, or components thereof. In some embodiments, the control system 100 is configured to provide autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 50, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, imagings, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein. Although various aspects of autonomous operation may be implemented by the controller 102, it should be understood that the controller 102 may also be configured to facilitate operation of the refuse vehicle by a vehicle operation, for example, based on operator inputs to the HMI 130.

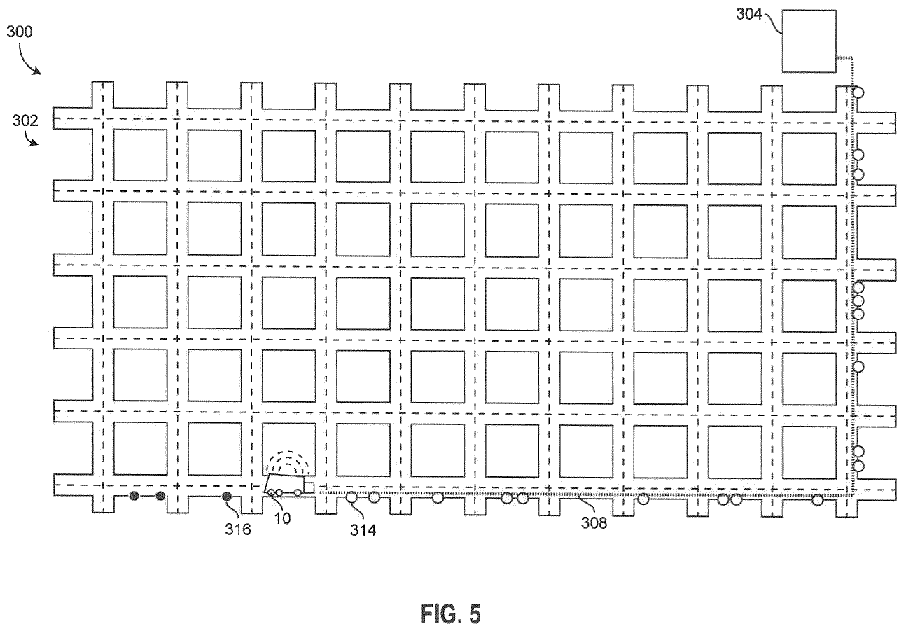

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Contaminant Detection System

Referring to FIGS. 1-10, a refuse vehicle 10 shown that includes a contaminant detection system 500, according to various exemplary embodiments. The contaminant detection system 500 is configured to detect or identify one or more objects, such as a contaminant 510, within refuse material contained within a refuse container 200. The contaminant detection system 500 includes one or more detection devices configured to obtain data (e.g., sensor data, image data, scan data, signals) indicative of the one or more objects, such as the contaminant 510, contained within the refuse container 200. The contaminant detection system 500 is configured to detect (e.g., identify) different contaminants (e.g., which may or may not be predefined) that may be a safety hazard to refuse collection and/or have specific disposal requirements (e.g., additional cost to dispose of the object, specific disposal methods for a contaminant), such as batteries (including lithium ion (Li-ion) batteries, lead-acid batteries, nickel-cadmium batteries (Ni—Cd), nickel-metal hydride (Ni-MH), and/or other types of batteries), chemicals, tires and other rubber objects, chemicals, canisters, tanks, appliances, oil cans, televisions and other large objects, tree materials, garden materials, etc. Although various contaminant detection methods and systems are described herein with respect to batteries, it should be appreciated that the same systems may be implemented to identify various other types of contaminants. For example, and depending on the desired waste materials to be received by the refuse vehicle, the contaminant may include recyclable materials or non-recyclable materials, inorganic waste, chemical waste, and/or various other types of materials and objects.

Refuse commonly includes trash mixed in with recyclables and/or other undesired objects/contaminants. For example, some studies have shown that upwards of approximately 25%, or greater, of recycling may be contaminated (e.g., including batteries, plastic bags, extruded polystyrene foam such as Styrofoam™, organics, etc.) with trash (e.g., non-recyclable materials). When recycling is contaminated, it adds costs to the recycling process, creates safety hazards (e.g., since some recyclables are flammable), and may even prevent recyclable materials from being recycled.

Contaminant detection can improve the capabilities of the refuse and recycling industry. For example, contaminant detection may be used to inform and reinforce with homeowners what materials are recyclable and which materials are contaminants (e.g., regular refuse). Furthermore, thermal events (e.g., fires) may occur when flammable garden waste and batteries end up in refuse containers. Contaminant detection can reduce the risk of these thermal events and enhance safety for refuse collectors. Moreover, contaminant detection can improve the efficiency of recycling operations, which can reduce greenhouse gas emissions associated with processing of recycled materials. Furthermore, refuse and recycling companies can account for contamination infractions in their accounting systems, providing a new revenue stream, while simultaneously supporting the environmental initiatives of the waste industry (e.g., lowering greenhouse gas emissions). Moreover, by using an object recognition technique as described herein, such as advanced vision system using artificial intelligence (AI) with on-the-edge (e.g., on vehicle) and/or cloud (e.g., remote computer/server) processing for object classification to identify contaminants within refuse increases recycling efficiency to further environmental efforts, lowers costs, improves safety, and creates new revenue opportunities for refuse and recycling companies.

Referring to FIG. 1, the refuse vehicle 10 may include a chassis 12, a body 14 coupled to the chassis 12, and a lift assembly 50 coupled to the body 14. The lift assembly 50 includes a grabber assembly 54 for engaging a refuse container 200. The refuse vehicle 10 may be configured in any embodiment disclosed in more detail herein. The refuse vehicle 10 further includes a contaminant detection system 500.

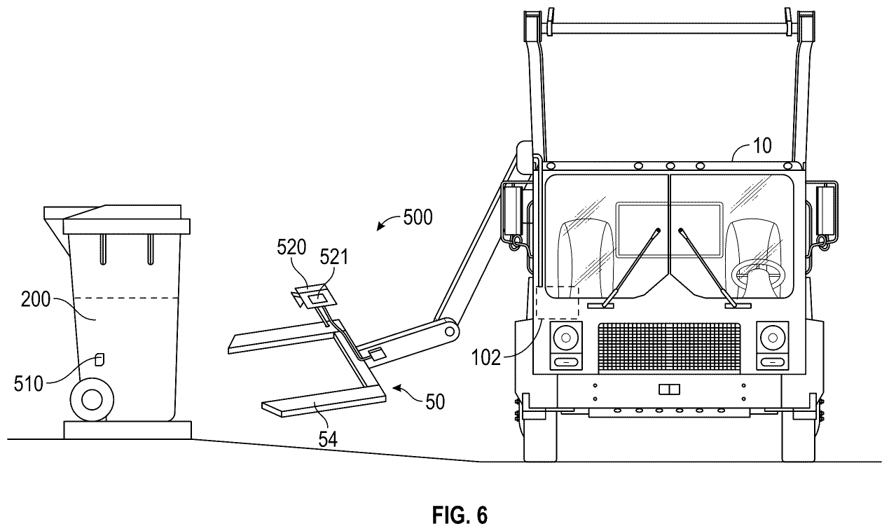

Referring to FIGS. 6-10, the contaminant detection system 500 includes a detection device 520 coupled to the lift assembly 50. The detection device 520 is configured to create data (e.g., scan data, sensor data, image data, signals, etc.) indicative of the refuse materials and any contaminants 510 contained within the refuse container 200. The contaminant detection system 500 further includes memory storing identifiers corresponding to the presence of a contaminant 510 within the refuse material. The contaminant detection system 500 further includes a controller 102 communicably coupled to the detection device 520. The controller 102 is configured to create a scan of the refuse material based on the scan data and/or the sensor data and determine, based on the scan and the identifiers, the presence of the contaminant 510 within the refuse material.

Referring to FIG. 6, the contaminant detection system 500 includes the detection device 520 positioned on the lift assembly 50 and/or the grabber assembly of the refuse vehicle. In the embodiment of FIG. 6, the detection device is positioned on a grabber assembly of the lift assembly 50. In some embodiments, the detection device 520 may be positioned on a pair of grabber arms 54 or a single grabber arm of the lift assembly 50. In some embodiments, the contaminant detection system 500 is coupled to a power source of the refuse vehicle (e.g., the engine, a battery pack, etc.) for operation of the contaminant detection system 500. The detection device 520 may be coupled to the power source of the refuse vehicle 10.

In some embodiments, the detection device 520 is configured to create scan data indicative of objects, including the contaminant 510, contained within the refuse container 200. In some embodiments, the detection device 520 includes a sensor 521. The sensor 521 may be configured to create sensor data indicative of the presence of objects, such as a battery (e.g., a battery cell, a battery pack, battery materials, etc.), contained within the refuse container 200. In some embodiments, the sensor 521 is positioned on the lift assembly 50. In some embodiments, the detection device 520 includes the sensor 521 positioned on a grabber arm of the lift assembly 50.

In some embodiments, the contaminant detection system 500 is configured to vary a setting of the detection device 520 (e.g., power level, intensity) to facilitate object/contaminant recognition within a refuse container. For example, the detection device 520 may be configured to operate using variable wavelengths, frequencies, and/or intensities for detecting the presence of the contaminant 510, depending on an embodiment of the detection device 520 used. In some embodiments, the controller 102 is configured to change the setting of the detection device 520 for detecting the contaminant 510.

Referring to FIGS. 1 and 6, the controller 102 is configured to receive various inputs from data sources. In some embodiments, the detection device 520 is communicably coupled to the controller 102. The controller 102 may receive data input from the detection device 520 of the contaminant detection system 500. For example, the controller 102 may receive data (e.g., scan data, sensor data, image data) from the detection device 520. In some embodiments, the controller 102 may receive data input from the sensor 521 of the detection device 520. In some embodiments, the controller 102 receives sensor data from the sensor 521 of the detection device 520.

In some embodiments, the controller 102 creates (e.g., generates) a scan (e.g., an image, a point cloud, etc.) of the refuse material contained within the refuse container 200 based on the data (e.g., sensor data, image data, scan data, signals, etc.) obtained from the detection device 520. The controller 102 may be configured to determine the presence of an object (e.g., the contaminant) based on the scan, for example, by applying an object recognition technique to the scan to detect or identify the presence of contaminants or a particular type of object contained within the refuse material within the refuse container 200.

In some embodiments, the controller 102 is configured to determine the presence of the contaminant 510 from the scan using a machine learning, an artificial intelligence, and/or a neural network technique. In other words, the controller 102 may be trained to associate features of the scan with known contaminants (e.g., scans of known contaminants captured using similar detection devices) to determine the presence of the contaminant 510 within the refuse contained in a refuse container 200.

In some embodiments, the controller 102 includes a memory 108. In some embodiments, the memory 108 may store data (e.g., identifiers) indicative of known contaminants and/or changes in properties of the known contaminants for use in the object recognition technique. For example, memory 108 stores identifiers corresponding to the presence of a contaminant within the refuse material (e.g., a change in thermal energy of a battery associated with heating the battery, a rate of change of temperature associated with microwaving a battery material, an electromagnetic signal associated with the battery material, a visual appearance of a battery, etc.). In some embodiments, the controller 102 determines the presence of the contaminant 510 within the refuse material based on the scan and the identifiers stored in the memory 108. In other words, the controller 102 may store data (e.g., identifiers) of known contaminants in memory 108 for determining the presence of the contaminant 510 by using the object recognition technique to compare the scan to the identifiers of the known contaminants.

In some embodiments, the detection device 520 may be movable by the grabber assembly and/or lift arm relative to the refuse container. For example, the detection device 520 may be repositioned relative to the refuse material within the refuse container to capture images and/or sensor data for creating multiple scans of the refuse from multiple positions and/or angles for detecting the presence of the contaminant 510 within the refuse container 200.

In some embodiments, the contaminant detection system 500 is used to detect the contaminant 510 contained within the refuse container 200 before the refuse vehicle 10 engages the refuse container 200. In some embodiments, the refuse may be deposited into an intermediate container for use of the contaminant detection system 500 (e.g., the contaminant detection system may be configured to analyze the intermediate container). The intermediate container may be attached to the refuse vehicle 10. In some embodiments, the refuse vehicle 10 engages the refuse container 200 using the lift assembly 50, where the contaminant detection system 500 is used to detect the presence of the contaminant 510 contained within the refuse container 200. The contaminant detection system 500 may be configured to detect the presence of the contaminant 510 before the refuse is deposited into the refuse vehicle 10. In some embodiments, the detection device 520 generates the sensor data before the refuse material enters the refuse vehicle 10 (e.g., before the refuse is dumped into the hopper of an onboard refuse container). In some embodiments, the controller 102 may create the scan before the refuse material enters the refuse vehicle 10, which can prevent further processing of the refuse material that may occur after a lift operation is performed.

The controller 102 may also be configured to facilitate removal of the contaminant from the waste stream. For example, if the controller 102 determines the presence of the contaminant 510, the controller 102 may be configured to generate an alert and/or prevent operation of one or more components of the refuse vehicle so as to prevent contaminant containing refuse materials from being deposited into the refuse vehicle until the contaminant 510 is removed from the refuse material contained within the refuse container 200.

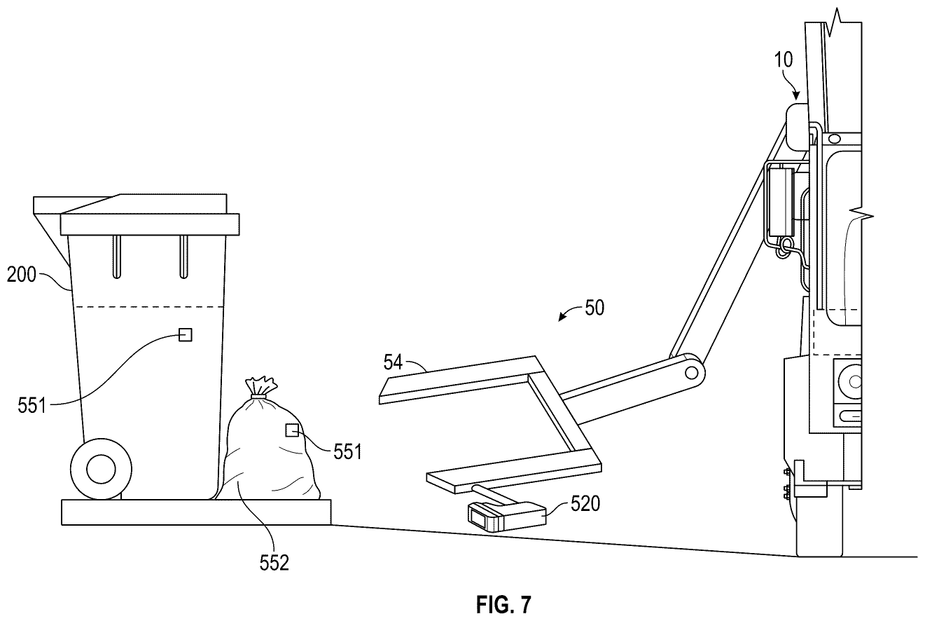

With reference to FIG. 7, the detection device 520 may be configured as a radio-frequency identification (RFID) detector. In such embodiments, the sensor 521 may include an RFID sensor. In some embodiments, the RFID detector may be configured to sense (e.g., using the RFID sensor) an RFID chip 551 on a refuse bag 552 and/or the refuse container 200 to detect and/or identify contaminants contained within the refuse container 200. For example, a customer may place the RFID chip 551 on the refuse bag 552 if the refuse material within the refuse bag includes contaminants. In some embodiments, the bag may encapsulate an RFID chip in an outer wall of the bag or in a pouch attached to the bag. In other embodiments, the refuse container may include an RFID chip or another identifier (e.g., a color, a barcode, a picture, etc.). In some embodiments, the customer may place the RFID chip 551 on the refuse container 200 to indicate the presence of contaminants within the refuse material.

The sensor 521 is configured to generate sensor data indicative of the type of contaminant and/or object based on data from the RFID chip 551. The controller 102 is communicably coupled to the sensor 521 and is configured to determine the presence of the contaminant during the refuse stream based on the sensor data. The controller 102 may be configured to signal the presence of contaminants within the refuse container 200 based on the RFID detector reading the RFID chip 551 on the refuse container 200.

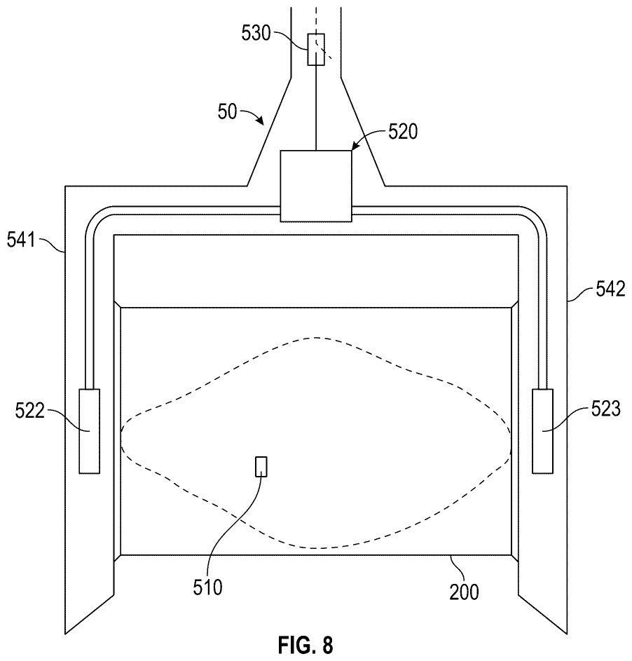

With reference to FIG. 8, in some embodiments, the detection device 520 includes multiple sensors that are each coupled to the grabber assembly and/or another portion of the lift system and/or refuse vehicle. For example, and as shown, the detection device 520 may include a first sensor 522 and a second sensor 523 that are both disposed on the pair of grabber arms 56 of the lift assembly 50. For example, the first sensor 522 may be positioned on a first grabber arm 541. The second sensor 523 is positioned on a second grabber arm 542.

In some embodiments, the detection device 520 is configured to scan through an outer wall of the refuse container (e.g., to emit waves that can propagate through a side of the refuse container 200, etc.) in order to detect the presence of the contaminant 510 and/or a particular object contained within the refuse container 200. The detection device 520 creates the scan data for the controller 102 to generate the scan and determine the presence of the contaminant 510 within the refuse container 200. In some embodiments, the first sensor 522 is a transmitter. The second sensor 523 may be a receiver. In some embodiments, the lift assembly 50 engages the refuse container 200, where the pair of grabber arms 54 engage the refuse container 200 on opposite sides, where the contaminant detection system 500 is configured for the transmitter (e.g., the first sensor 522) to emit a wave propagating through a first side of the refuse container 200. The receiver (e.g., the second sensor 523) receives signals (e.g., the wave) through a second side of the refuse container 200 opposite from the first side from the transmitter. The receiver generates sensor data (e.g., scan data) indicative of objects, including contaminants, contained in the refuse container 200 based on signals received from the transmitter. The receiver is communicably coupled to the controller 102 to transmit the sensor data to the controller 102, where the controller 102 creates the scan based on the sensor data. The controller 102 is configured to determine the presence of the contaminant 510 contained within the refuse container 200 based on the scan. The controller 102 may be configured to determine the presence of the contaminant 510 based on the scan and the identifiers stored in the memory 108 (e.g., by comparing the scan of the refuse material within the container to known scans of contaminants and/or known scans of contaminants contained within refuse captured using a similar detection device).

In some embodiments, the detection device 520 is an electromagnetic imaging device. For example, the detection device 520 may be an X-Ray imaging device. In some embodiments, the electromagnetic imaging device may include the first sensor 522 and the second sensor 523 positioned on the pair of grabber arms 54 of the lift assembly 50. In some embodiments, the first sensor 522 is the transmitter configured to emit an electromagnetic wave (e.g., an X-Ray transmitter). The second sensor 523 may be the receiver (e.g., an X-Ray receiver). In some embodiments, the first sensor 522, the transmitter, is positioned on the first grabber arm 541 and the second sensor 523, the receiver, is positioned on the second grabber arm 542.

In some embodiments, the lift assembly 50 engages the refuse container 200, where the pair of grabber arms 54 engage the refuse container 200 on opposite sides, where the contaminant detection system 500 is configured for the transmitter (e.g., the X-Ray transmitter) to emit the electromagnetic wave through the side of the refuse container 200. The receiver (e.g., the X-Ray receiver) receives the electromagnetic wave through the side of the refuse container 200. The receiver creates sensor data indicative of objects, including contaminants, contained in the refuse container 200 based on receiving the electromagnetic wave. The receiver is communicably coupled to the controller 102 to transmit the sensor data to the controller 102, where the controller 102 creates the scan based on the sensor data. The scan may be an electromagnetic image. For example, the scan may be a radiograph (e.g., an X-Ray image) of the refuse material. The controller 102 may be configured to determine the presence of the contaminant 510 contained within the refuse container 200 using the object recognition technique on the radiograph. The controller 102 may be configured to determine the presence of the contaminant 510 based on the scan (e.g., the radiograph) and the identifiers stored in the memory 108 (e.g., by comparing the image of the refuse to known images of contaminants and/or known images of contaminants contained within refuse captured using an electromagnetic imaging device). In some embodiments, when the detection device 520 is configured as the electromagnetic imaging device, the detection device 520 may be configured to vary a wavelength of the electromagnetic wave for detecting the presence of the contaminant 510 contained within the refuse container 200, which can improve the accuracy of contaminant detection and/or facilitate identification of certain types of objects/contaminants (e.g., certain types of battery materials, etc.).

In some embodiments, the detection device 520 is a particle imaging device (e.g., neutron imaging, proton imaging, or electron detection device). In some embodiments, the particle imaging device is configured to emit a particle beam to interact with a desired material within the refuse container 200, such as the contaminant 510. In some embodiments, the particle imaging device includes one or more sensors, where the first sensor 522 is the transmitter positioned on the first grabber arm 541 and the second sensor 523 is the receiver positioned on the second grabber arm 542. The lift assembly 50 may engage the refuse container 200 with the pair of grabber arms 54 positioned on opposite sides of the refuse container 200. The particle imaging device emits the particle beam through the side of the refuse container 200 from the transmitter to interact with the contaminant 510 contained within the refuse container 200, where the particle beam is received by the receiver. The receiver creates sensor data indicative of objects, including contaminants, contained in the refuse container 200 based on receiving the particle beam. The receiver transmits the sensor data (e.g., the particle beam) to the controller 102, where the controller 102 creates the scan based on the sensor data. The scan may be a particle image (e.g., neutron image) of the refuse. The controller 102 determines the presence of the contaminant 510 contained within the refuse container 200 using the data recognition technique on the particle image. The controller 102 may be configured to determine the presence of the contaminant 510 based on the scan (e.g., the particle image) and the identifiers stored in the memory 108 (e.g., by comparing the image of the refuse to known images of contaminants and/or known images of contaminants contained within refuse captured using a particle imaging device). In some embodiments, when the detection device 520 is configured as the particle imaging device, the detection device 520 may be configured to vary a beam intensity of the particle beam for detecting the presence of the contaminant 510 contained within the refuse container 200.

In some embodiments, the detection device 520 (e.g., the electromagnetic imaging device) is selectively coupled to the power source on the refuse vehicle 10. For example, when the contaminant detection system 500 is in use, the detection device 520 is coupled to the power source on the refuse vehicle 10 (e.g., a high voltage power source at greater current/voltage than required for other onboard vehicle components) to power the detection device 520 for operation. In some embodiments, the contaminant detection system 500 includes a power disconnect 530 (e.g., a power switch) positioned on the lift assembly 50. In some embodiments, the power disconnect 530 is positioned on the refuse vehicle 10. In some embodiments, the power disconnect 530 is positioned between the detection device 520 and the power source of the refuse vehicle 10. The power disconnect 530 is used to selectively couple the detection device 520 to the power source. In some embodiments, the controller 102 may selectively couple the detection device 520 to the power source using the power disconnect 530. For example, when the detection device 520 is the electromagnetic imaging device, the power disconnect 530 may be used to decouple the detection device 520 from the power source to save power for the refuse vehicle 10 when imaging is not required (e.g., when the vehicle is in transit), since electromagnetic imaging requires a large amount of power. In some embodiments, the power disconnect 530 may be used to decouple the detection device 520 from the power source for safety considerations and/or to facilitate servicing of the contaminant detection system 500.

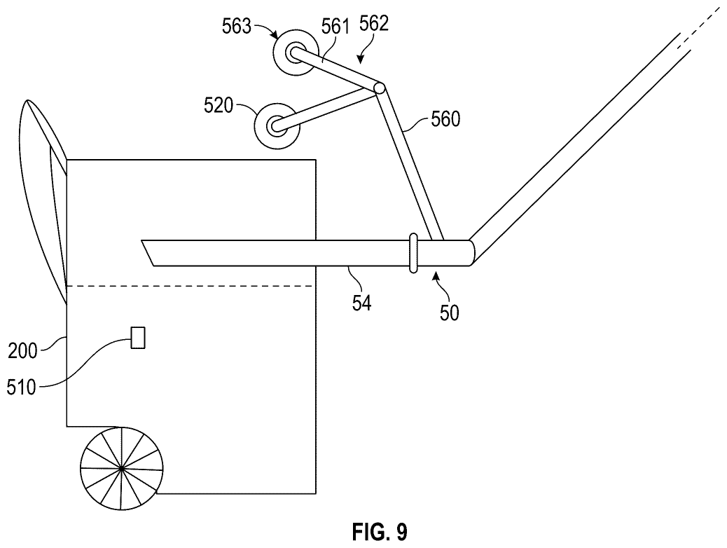

With reference to FIG. 9, the detection device 520 may include a magnetic detection device. For example, the detection device 520 may include a metal detector. In some embodiments, the detection device 520 is configured to detect a desired (e.g., target, trigger, etc.) element. For example, the desired element may be nickel, cadmium, lithium, or another material that is specific to the construction of various types of batteries or other objects/contaminants. In some embodiments, the detection device 520 is configured to detect a desired material. For example, the case material of a battery may be the desired material. In some embodiments, the detection device 520 is configured to emit a magnetic field to detect magnetic properties of the contaminant 510. For example, the magnetic field may interact with the desired element and/or the desired material. In some embodiments, the detection device 520 emits the magnetic field to interact with multiple elements and/or materials. In some embodiments, when the detection device 520 is configured as the metal detector, the detection device 520 may be configured to vary an intensity of the magnetic field for detecting the presence of the contaminant 510 contained within the refuse container 200.

With continued reference to FIG. 9, the contaminant detection system 500 includes an insertion arm 560 for use in collecting the scan data. The insertion arm 560 may be inserted into the refuse container 200 for scanning the refuse. In some embodiments, the insertion arm 560 includes the detection device 520. For example, the lift assembly 50 may engage the refuse container 200. The lift assembly 50 may remove a lid of the refuse container 200 (e.g., using a robotic arm positioned on the lift assembly 50). The insertion arm 560 may be used to remove the lid of the refuse container 200. In some embodiments, the insertion arm 560 is inserted into the refuse container 200 for the detection device 520 to collect scan data for determining the presence of the contaminant 510 within the refuse container 200.

In some embodiments, when the detection device 520 may be positioned on a finger 561 of the insertion arm 560. In some embodiments, the insertion arm 560 may include a plurality of fingers 562 at an insertion end 563 of the insertion arm 560. The contaminant detection system 500 may include a plurality of detection devices. For example, each finger 561 of the insertion arm 560 may include a detection device 520 of the plurality of detection devices. The insertion arm 560 may be inserted into the refuse container 200 so each detection device of the plurality of detection devices may detect the contaminant 510. In some embodiments, the finger 561 includes the detection device 520 configured as the metal detector. Each finger 561 of the insertion arm 560 may include the detection device 520 of the plurality of detection devices configured as the metal detector. The insertion arm 560 may be inserted into the refuse container 200 where each metal detector on the plurality of fingers 562 of the insertion arm 560 emits a magnetic field to detect the presence of the contaminant 510 within the refuse contained within the refuse container 200. Each metal detector of the plurality of fingers 562 of the insertion arm may be configured according to an embodiment of the metal detector as described herein.

In some embodiments, the detection device 520 is a camera. The camera captures scan data of the refuse contained within the refuse container 200. For example, the camera captures the scan data by capturing image data (e.g., capture images). The camera is communicably coupled with the controller 102 to transmit the image data for the controller 102 to determine the presence of the contaminant 510 within the refuse contained in the refuse container 200. In some embodiments, the controller 102 creates the scan based on the image data. In some embodiments, the controller 102 is programed to identify the presence of the contaminant 510 based on the image data. For example, the controller 102 may be trained so the object recognition technique recognizes the appearance of the contaminant 510 (e.g., a battery) to determine the presence of the contaminant 510 in the refuse container 200. In some embodiments, when the detection device 520 is configured as the camera, the detection device 520 may be configured to vary an imaging setting (e.g., frame rate, definition) for detecting the presence of the contaminant 510 contained within the refuse container 200.

In some embodiments, the camera is positioned on the insertion arm 560. The camera may be positioned within a protective housing for insertion into the refuse container 200. In some embodiments, the insertion arm 560 including the camera is inserted into the refuse container 200 to capture image data. The insertion arm 560 may be inserted into the refuse container 200 in multiple positions and/or at various angles to capture the sensor data. For example, the camera may be inserted into the refuse container 200 and moved around the refuse container 200 to capture the image data for a plurality of images. In some embodiments, the camera may capture the image data as a video and/or a live-stream. The camera may be positioned in multiple positions and/or angles to capture the image data. The camera may be positioned on the insertion arm 560 and configured to capture the image data as the video and/or the live-stream when the insertion arm 560 moves the camera around the refuse container 200.

In some embodiments, the detection device 520 is a thermal imaging device. For example, the detection device 520 may be a thermal camera. In some embodiments, the thermal imaging device may detect thermal energy (e.g., thermal radiation) from objects within the refuse container 200 to create thermal scan data (e.g., thermal image data) indicative of the presence of objects, such as the contaminant 510, within the refuse material in the refuse container 200. In some embodiments, the thermal imaging device may include a thermal sensor to detect the thermal energy from objects within the refuse container 200 to create the scan data. In some embodiments, the thermal imaging device is communicably coupled with the controller 102 to send the scan data, where the controller 102 creates the scan (e.g., the image). The scan may be a thermal image of the refuse material including the contaminant. The controller 102 is configured to determine the presence of the contaminant 510 in the refuse container 200 using the object recognition technique on the thermal scan. The controller 102 may be configured to determine the presence of the contaminant 510 based on the scan (e.g., the thermal scan) and the identifiers stored in the memory 108 (e.g., by comparing heat signatures of objects detected in the refuse with known heat signatures of objects, such as contaminants). In some embodiments, when the detection device 520 is configured as the thermal camera, the detection device 520 may be configured to vary a setting (e.g., an imaging setting such as frame rate and/or a thermal setting such an intensity or sensitivity) for detecting the presence of the contaminant 510 contained within the refuse container 200.

In some embodiments, the thermal camera may be positioned to capture the thermal scan of the refuse directly. In some embodiments, the thermal camera may be positioned to capture the image by capturing the image of the refuse contained in the refuse container 200 (e.g., looking directly at the refuse contained within the refuse container 200). In some embodiments, the thermal camera may be positioned to capture the image by capturing the image of the side of the refuse container 200 (e.g., to collect the scan data for the controller to 102 to create a heat map of the refuse contained within the refuse container 200 through the side of the refuse container).

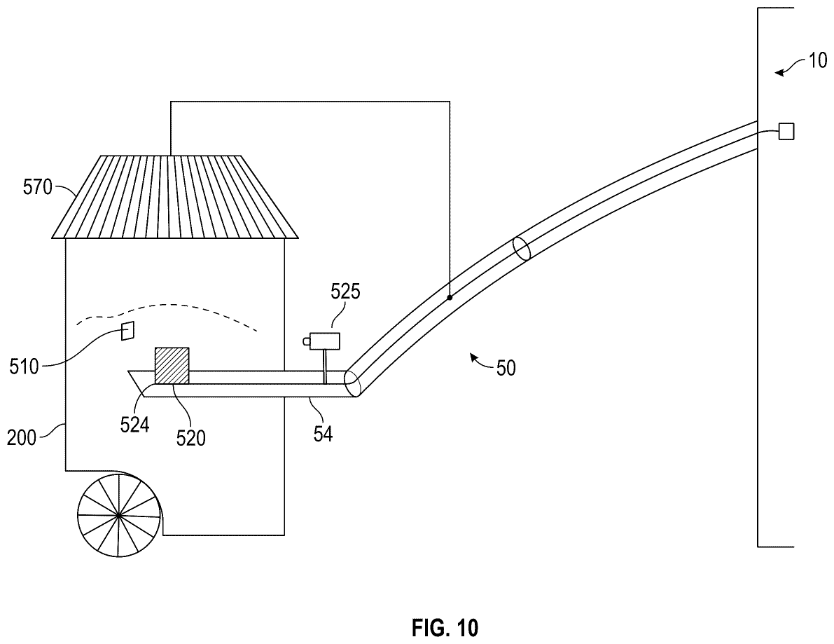

With reference to FIG. 10, the contaminant detection system 500 includes an agitator 570 (e.g., an exciter, etc.). The agitator 570 may be configured to cause the contaminant 510 to react and/or express a property so the detection device 520 may detect the contaminant 510. The contaminant detection system 500 may capture the scan data and/or the sensor data by agitating the refuse contained within the refuse container 200 (e.g., shaking the container, heating the container, adding a reactant to the container, microwaving the container). In some embodiments, the contaminant detection system 500 may capture data before, during, and/or after agitation (e.g., continuously or semi-continuously during operation of the agitator 570). Monitoring the conditions of the refuse material during agitation or at different points throughout the agitation process can facilitate recognition of contaminants within the refuse material as different materials will behave differently during agitation.

In some embodiments, the contaminant detection system 500 does not agitate the refuse to capture the scan data and/or the sensor data. In some embodiments, the agitator 570 is positioned on the lift assembly 50 of the refuse vehicle 10. In some embodiments, any configuration of the agitator 570 may be used with any configuration of the detection device 520, as disclosed herein.

In some embodiments, and as described above, the contaminant detection system 500 uses the agitator 570 in conjunction with the detection device 520 to detect the contaminant 510 (e.g., agitation causes the contaminant to be detectable by the detection device). In some embodiments, the agitator 570 may be used by the contaminant detection system 500 for the controller 102 to create a second scan. The controller 102 may create a first scan (e.g., the image) based on the image and/or sensor data before agitation, and then the contaminant detection system 500 may use the agitator 570 on the refuse so the controller 102 may create the second scan based on the scan data and/or the sensor data during and/or after agitation. In some embodiments, the contaminant detection system 500 is configured to capture, using the detection device 520, a first scan data and/or a first sensor data before agitation and then capture a second scan data and/or a second sensor data during and/or after agitation, for the controller 102 to create the first scan and the second scan to detect the presence of the contaminant 510 within the refuse contained within the refuse container 200. The controller 102 may use the object recognition technique to determine the presence of the contaminant 510 by comparing the first scan to the second scan to detect the contaminant. For example, the controller 102 may be programmed with known data corresponding to the contaminant based on an amount of agitation applied to the refuse (e.g., a known change in some property of the contaminant 510 corresponding to the amount of agitation applied and the detection device 520 used). The contaminant detection system 500 may be configured to capture the first scan data and/or the first sensor data and the second scan data and/or the second sensor data using any embodiment of the detection device 520 as disclosed herein.

In some embodiments, the agitator 570 is configured to emit a magnetic field. For example, the agitator 570 may emit the magnetic field when the contaminant has magnetic properties, so the detection device 520 may detect the contaminant 510 (e.g., by magnetically attracting the contaminant to the detection device). In some embodiments, the agitator 570 configured to emit the magnetic field is used with the detection device 520 configured as the metal detector. In some embodiments, the agitator 570 may be the metal detector. In some embodiments, the agitator 570 may be used to increase the magnetic field for the metal detector to detect the contaminant 510.

In some embodiments, the agitator 570 may be configured to vibrate. For example, the agitator 570 may shake the refuse and/or the refuse container 200, thereby moving the refuse around said container, so the detection device 520 may detect the contaminant 510. In some embodiments, the agitator 570 configured to vibrate may be used in conjunction with the detection device 520 configured as the camera. For example, agitating the refuse by moving the refuse around the refuse container 200 may increase the effectiveness of using the camera to capture scan data to detect the contaminant 510 within the refuse container 200. In other words, moving the refuse around may reveal previously covered refuse for the camera to capture scan data for detecting the contaminant 510. In some embodiments, the agitator 570 configured to vibrate may be used in conjunction with the detection device 520 configured as the metal detector. For example, moving the refuse around may increase interaction between the magnetic field emitted by the metal detector and the refuse within the refuse container 200 (e.g., buried refuse may be brought near the metal detector by agitation for the metal detector to detect the contaminant 510). In some embodiments, the agitator 570 may be positioned on the lift assembly 50. The agitator 570 may be positioned on the pair of grabber arms 54 of the lift assembly 50. In some embodiments, the pair of grabber arms 54 and/or the lift assembly 50 may be configured to shake the refuse container 200. The agitator 570 may shake the refuse container 200 to agitate the refuse contained within the refuse container 200.

In some embodiments, the agitator 570 is configured to heat the refuse. For example, the agitator 570 may emit heat for the detection device 520 to detect the contaminant 510 (e.g., to increase and/or change a thermal energy of the contaminant 510 within the refuse for detection). In some embodiments, the agitator 570 may emit heat for the detection device 520 to detect the contaminant 510 via a change in the thermal energy of the contaminant 510 within the refuse. In some embodiments, the agitator 570 may be configured to emit radiation. For example, the agitator 570 may emit microwave radiation to change the thermal energy of the refuse for the detection device to detect the contaminant 510. In some embodiments, the detection device 520 is configured as the thermal camera for use with the agitator 570 configured to heat and/or radiate the refuse.

With reference to FIG. 10, the agitator 570 is configured to fit over the refuse container 200 (e.g., like a lid). In some embodiments, the agitator 570 is configured as a cone to fit over an opening of the refuse container 200. The agitator 570 may emit radiation to increase the thermal energy of the contaminant 510 within the refuse. In some embodiments, the contaminant detection system 500 includes the detection device 520 as the thermal camera. The thermal camera may be positioned within the agitator 570 configured as the cone to fit over the opening of the refuse container 200. The thermal camera may capture the first scan data. For example, the first scan data may be indicative of the thermal energy of objects, including the contaminant 510, contained within the refuse container 200. The first scan data is transmitted to the controller 102 to create a first thermal image based on the first scan data. The contaminant detection system 500 may use the agitator 570 configured to emit radiation to emit said radiation and increase the thermal energy of objects, including the contaminant 510, contained within the refuse container 200. The thermal camera may capture the second scan data. For example, the second scan data may also be indicative of the thermal energy of objects contained within the refuse container 200, where the thermal energy of objects contained within the refuse container 200 was changed via use of the agitator 570. The second scan data is transmitted to the controller 102 to create a second thermal image. The controller 102 may use the object recognition technique to determine the presence of the contaminant 510 by comparing the first thermal image to the second thermal image to detect the contaminant 510 by a change in thermal energy of the contaminant 510. For example, the controller 102 may be programmed with a known change in the thermal energy of the contaminant 510 corresponding to an amount of radiation emitted by the agitator 570. In some embodiments, the controller 102 may use the object recognition technique on the second thermal image to detect the presence of the contaminant 510. For example, radiating the refuse may make the contaminant 510 detectable by the thermal camera based off the second thermal image.

In some embodiments, the agitator 570 may be configured to crush and/or grind the refuse. For example, the agitator 570 may crush the refuse, where the contaminant 510 expresses detectable properties by crushing, so the detection device 520 may detect the contaminant (e.g., crushing the contaminant 510 may release a chemical that is detectable by the detection device 520). In some embodiments, the detection device 520 includes the sensor 521 configured to detect chemical properties of the contaminant 510. For example, the contaminant 510 may emit a gas when in the refuse contained within the refuse container 200, and the sensor 521 detects a presence of the gas emitted by the contaminant 510. The sensor 521 creates the sensor data indicative of the presence of the contaminant 510 contained within the refuse container based on the gas emitted by the contaminant 510. The sensor 521 is communicably coupled to the controller 102, which alerts the contaminant detection system 500 to the presence of the contaminant 510 within the refuse contained within the refuse container 200. In some embodiments, the contaminant 510 emits the gas without agitation (e.g., without being crushed) for the detection device 520 to detect the presence of the contaminant 510 within the refuse container 200. In some embodiments, agitating the refuse may increase the emission of the gas by the contaminant 510 for detection of the presence of the contaminant 510 by the detection device 520.

With reference to FIG. 10, the contaminant detection system 500 includes multiple detection devices. The contaminant detection system 500 may include 1, 2, 3, 4 or more detection devices. In some embodiments, the contaminant detection system 500 may include a second detection device 525. The second detection device 525 may be configured according to an embodiment of the detection device 520 as disclosed herein. In some embodiments, the second detection device 525 may be the same type as a first detection device 524 (e.g., the detection device 520). In some embodiments, the second detection device 525 and the first detection device 524 are different types of detection devices. For example, the first detection device 524 may be the electromagnetic imaging device and the second detection device 525 may be the thermal camera. In some embodiments, the contaminant detection system 500 includes the second detection device 525 to increase effectiveness of the contaminant detection system 500 in detecting the contaminant 510. For example, if the second detection device 525 is configured differently than the first detection device 524, then the contaminant detection system 500 may use two detection methods to detect the contaminant 510, increasing the effectiveness of detecting the contaminant 510. In some embodiments, the contaminant detection system 500 includes the second detection device 525 to increase the accuracy of the contaminant detection system 500 in detecting the contaminant 510 (e.g., using multiple detection devices to address false positives). For example, the second detection device 525 may be used to verify detection of the contaminant 510 by the first detection device 524. For example, the detection device 520 may detect an abnormality (e.g., the contaminant, an object similar to the contaminant causing a false positive, etc.) within the refuse material, where the second detection device 525 operates to determine (e.g., confirm) the presence of the contaminant in the refuse material. In some embodiments, the first detection device 524 and the second detection device 525 are operated simultaneously for contaminant detection.

In some embodiments, the contaminant detection system 500 including the second detection device 525 is configured to create the second scan for detecting the presence of the contaminant 510. In some embodiments, the second detection device 525 creates the second scan data and/or the second sensor data indicative of objects, including the contaminant 510, within the refuse container 200. The second sensor data is transmitted to the controller 102 to create the second scan. In some embodiments, the controller 102 determines the presence of the contaminant 510 contained within the refuse container 200 using the object recognition technique on the second scan. For example, the controller 102 may determine the presence of the contaminant 510 using the object recognition technique on the first scan, and then verify the presence of the contaminant 510 using the object recognition technique on the second scan. In some embodiments, the controller 102 determines the presence of the contaminant 510 based on using the object recognition technique to compare the first scan and the second scan.

In some embodiments, where the contaminant detection system 500 includes multiple detection devices, the first detection device 524 and the second detection device 525 may be positioned differently. For example, the first detection device 524 and the second detection device 525 may be positioned at different locations and/or angles to capture multiple scans of the refuse. In some embodiments, the first detection device 524 and the second detection device 525 may be movable. The first detection device 524 and/or the second detection device 525 may be repositioned to capture scan and/or sensor data for creating multiple scans of the refuse for detecting the presence of the contaminant 510. In some embodiments, the contaminant detection system 500 is configured for the detection device 520 to create 1, 2, 3, 4 or more sets of scan and/or sensor data. The controller 102 may create 1, 2, 3, 4 or more scans based on the scan and/or sensor data for detecting the contaminant 510 contained within the refuse container 200. The controller 102 may be configured to determine the presence of the contaminant 510 based on using the object recognition technique on the multiple scans.

With continued reference to FIG. 10, the contaminant detection system 500 includes the first detection device 524 and the second detection device 525. The contaminant detection system 500 may further include the agitator 570. In some embodiments, the contaminant detection system 500 uses the first detection device 524 to capture the first sensor data and/or the first scan data of the refuse contained within the refuse container 200. The controller 102 may create the first scan based on the first sensor data and/or the first scan data. In some embodiments, where the controller 102 determines that the contaminant 510 is present within the refuse container using the object recognition technique on the first scan, the contaminant detection system 500 uses the second detection device 525 to capture the second sensor data and/or the second scan data of the refuse contained within the refuse container 200. The controller 102 may create the second scan based on the second sensor data and/or the second scan data. In some embodiments, the controller 102 verifies the presence of the contaminant 510 by using the object recognition technique on the second scan. In some embodiments, the contaminant detection system 500 may use the agitator 570 to agitate the refuse after the controller 102 determines the presence of the contaminant 510 based on the first scan. The second detection device 525 is used after and/or during agitation for creation of the second scan by the controller 102.

With continued reference to FIG. 10, the contaminant detection system 500 includes the first detection device 524 configured as the electromagnetic detection device (e.g., X-Ray imaging device) and the second detection device 525 configured as the thermal camera. The contaminant detection system 500 further includes the agitator 570 configured to emit radiation (e.g., configured as the cone to fit over the refuse container 200 as described herein). In some embodiments, the contaminant detection system 500 uses the electromagnetic imaging device to capture the first sensor data of the refuse contained within the refuse container 200. The controller 102 may create the first scan based on the first sensor data. In some embodiments, where the controller 102 determines that the contaminant 510 is present within the refuse container 200 using the object recognition technique, the contaminant detection system 500 uses the thermal camera to create the second sensor data. The controller 102 creates the second scan based on the second sensor data. In some embodiments, the controller 102 verifies the presence of the contaminant 510 based on using the object recognition technique on the second scan.

In some embodiments, when the controller 102 determines the presence of the contaminant 510 based on the first scan and/or the second scan, the contaminant detection system 500 agitates the refuse using the agitator 570. For example, the agitator 570 emits microwave radiation to increase the thermal energy of the contaminant 510. In some embodiments, the contaminant detection system 500 uses the thermal camera to create a third sensor data. The controller 102 creates a third scan based on the third sensor data. In some embodiments, the controller 102 determines the presence of the contaminant 510 by using the object recognition technique to compare the second scan and the third scan to determine the presence of the contaminant 510 based on the change in thermal energy of the contaminant 510 (e.g., by comparing the change in thermal energy present in the second and third scans to known changes in thermal energy of contaminants).

In some embodiments, when the contaminant detection system 500 detects the presence of the contaminant 510 within the refuse container 200, the refuse contained within the refuse container 200 is not deposited into the refuse vehicle 10 until the contaminant 510 is removed. For example, based on detecting the presence of the contaminant 510, the controller 102 may flag (e.g., track, record, etc.) the refuse material and/or the refuse container 200 with the contaminant 510 therein (e.g., to notify an operator of the refuse vehicle, to provide indication of the contaminant so a customer corresponding to the refuse container 200 so the customer can be notified of the contaminant, to provide indication of the contaminant to separate the refuse material collected from the refuse container 200, etc.). For example, the controller 102 may generate a notification indicative of the presence of the contaminant within the refuse material (e.g., to transmit to a customer, an internal notification in the controller for display to a user, etc.). In some embodiments, the contaminant 510 may be removed by automated methods. In some embodiments, the contaminant 510 may be removed by a refuse vehicle operator. In some embodiments, the presence of the contaminant 510 may be used to sort the refuse contained within the refuse container 200 for depositing into the refuse vehicle 10 (e.g., recorded as trash to not be recycled). In some embodiments, the contaminant detection system 500 detecting the presence of the contaminant 510 results in a communication (e.g., notification) to a customer. The customer may be reminded and/or informed about including contaminants in refuse. The customer may be charged a fee for including the contaminant. Other actions may be undertaken after the contaminant 510 is detected within the refuse container 200.

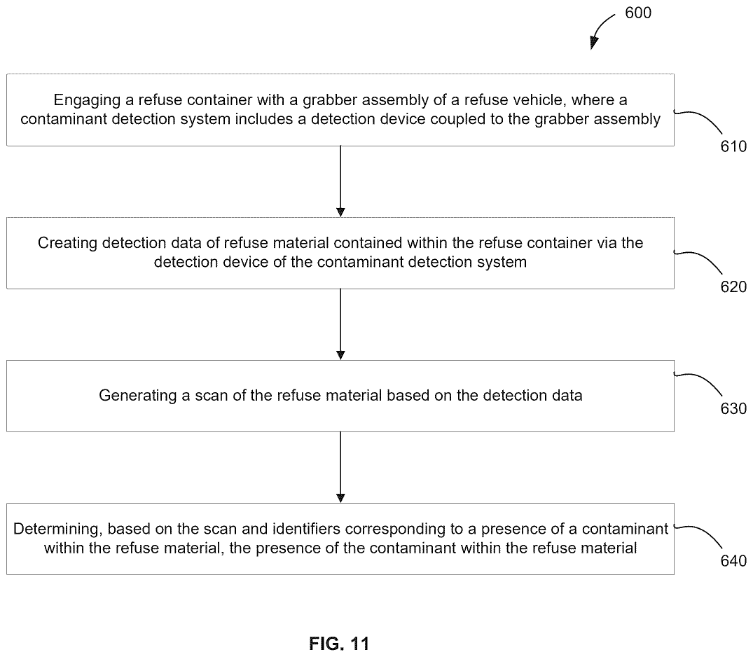

Referring to FIG. 11, a method 600 for detecting a contaminant within refuse material is depicted. The method 600 may be carried out (e.g., completed, etc.) with an embodiment of the contaminant detection system 500, such as when onboard the refuse vehicle 10, as described herein. For example, the method 600 may be used to detect the contaminant within refuse material stored within a refuse container, where the refuse container is engaged by a grabber assembly of the refuse vehicle. In some embodiments, the method 600 may include additional, fewer, and/or a different order of method steps (e.g., operations).

The method 600 may include engaging a refuse container with a grabber assembly of a refuse vehicle, where a contaminant detection system includes a detection device coupled to the grabber assembly, at 610. For example, the detection device is configured to detect the presence of the contaminant within the refuse material. The detection device may be, but is not limited to, an electromagnetic scanning device (e.g., an X-ray imaging device, etc.), a thermal imaging device (e.g., a thermal camera, etc.), a magnetic detection device (e.g., a metal detector, etc.), a visual imaging device (e.g., a camera, etc.), and/or a particle imaging device (e.g., neutron imaging, proton imaging, or electron detection device).

The method 600 may include creating detection data of refuse material contained within the refuse container via the detection device of the contaminant detection system, at 620. For example, the contaminant detection system may include a controller communicably coupled to the detection device. The detection device creates the detection data (e.g., scan data, signal indicative of a presence of a target object, such as the contaminant, etc.). The detection device may transmit the detection data to the controller. The method 600 may include generating a scan (e.g., image, profile, plot, workup, etc.) of the refuse material based on the detection data, at 630. For example, the controller may generate the scan of the refuse material. The method 600 may include determining, based on the scan (e.g., and/or the detection data) and identifiers corresponding to a presence of a contaminant within the refuse material, the presence of the contaminant within the refuse material, at 640. For example, the controller may store (e.g., in memory thereof) the identifiers, where the identifiers correspond to a type of detection device used to detect the contaminant, as described herein. The controller may compare the scan and/or the detection data to the identifiers to determine the presence of the contaminant.

In some embodiments, the method 600 may include flagging (e.g., tracking, recording, etc.) the refuse material and/or the refuse container with the contaminant therein. For example, the method 600 may include generating a notification indicative of the presence of the contaminant within the refuse material (e.g., to transmit to a customer, an internal notification in the controller for display to a user, etc.). In some embodiments, based on detecting the presence of the contaminant, the method 600 may include one or more of, sorting (e.g., separating) the refuse material contained within the refuse container (e.g., to remove the contaminant, to dispose of as a different type of refuse, such as trash instead of recycling, etc.), and/or transmitting a notification to a customer indicative of the contaminant (e.g., remind and/or inform about including contaminants in refuse, charge a fee for including the contaminant, etc.).

In some embodiments, the method 600 may include agitating the refuse material via an agitator, where the contaminant detection system includes the agitator. For example, agitating the refuse may be completed using an embodiment of the agitator 570, as described herein. Agitating the refuse material may cause the contaminant to react and/or express a property so the detection device may detect the contaminant. For example, the contaminant detection system may capture the scan data and/or the sensor data by agitating the refuse contained within the refuse container (e.g., shaking the container, heating the container, adding a reactant to the container, microwaving the container), such that by monitoring the conditions of the refuse material during agitation and/or at different points throughout the agitation process can facilitate recognition of contaminants within the refuse material as different materials will behave differently during agitation.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It is noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (e.g., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A refuse vehicle, comprising:
a chassis;
a body coupled to the chassis;
a grabber assembly coupled to the body, the grabber assembly configured to engage a refuse container; and
a contaminant detection system, comprising:
a detection device coupled to the grabber assembly, the detection device configured to create scan data of refuse material contained within the refuse container; and
a controller communicably coupled to the detection device, the controller comprising one or more processors communicably coupled to a memory, the memory storing identifiers corresponding to a presence of a contaminant within the refuse material, the controller configured to:
generate a scan of the refuse material based on the scan data; and
determine, based on the scan data and the identifiers, the presence of a contaminant within the refuse material.

2. The refuse vehicle of claim 1, wherein the contaminant detection system further comprises an agitator, wherein the agitator is configured to agitate the refuse material contained within the refuse container during operation of the detection device.

3. The refuse vehicle of claim 2, wherein the controller is further configured to:
generate a first scan of the refuse material before operation of the agitator;
generate a second scan of the refuse material after operation of the agitator; and
determine the presence of the contaminant by comparing the first scan and the second scan.

4. The refuse vehicle of claim 1, wherein the detection device comprises an electromagnetic scanning device.

5. The refuse vehicle of claim 4, wherein the electromagnetic scanning device includes a first sensor positioned on a first grabber arm of the grabber assembly and a second sensor positioned on a second grabber arm of the grabber assembly that is configured to receive signals from the first sensor.

6. The refuse vehicle of claim 4, wherein the scan generated by the controller is an electromagnetic image, and wherein the identifiers corresponding to the presence of the contaminant within the refuse material comprise an electromagnetic signal associated with a material of the contaminant.

7. The refuse vehicle of claim 1, wherein the detection device is a first detection device, and the contaminant detection system further comprises a second detection device.

8. The refuse vehicle of claim 7, wherein the second detection device comprises a thermal imaging device.

9. The refuse vehicle of claim 8, wherein the controller is configured to:
generate a first scan of the refuse material based on scan data from the first detection device;
determine, based on the scan data and the identifiers, an abnormality within the refuse material;
generate a second scan of the refuse material based on scan data from the second detection device; and
determine, based on the second scan and the identifiers, the presence of the contaminant within the refuse material.

10. The refuse vehicle of claim 1, further comprising a power source and a power disconnect, wherein the detection device is selectively coupled to the power source via the power disconnect.

11. The refuse vehicle of claim 10, wherein the controller is configured to actuate the power disconnect to electrically disconnect the detection device from the power source when the detection device is not creating scan data of the refuse material.

12. A refuse vehicle, comprising:
a chassis;
a body coupled to the chassis;
a grabber assembly coupled to the body, the grabber assembly configured to engage a refuse container; and
a contaminant detection system, comprising:
a detection device coupled to the grabber assembly, the detection device configured to generate sensor data indicative of a presence of a contaminant within refuse material contained within the refuse container; and
a controller communicably coupled to the detection device, the controller configured to generate a notification responsive to sensor data indicating the presence of a contaminant in the refuse material.

13. The refuse vehicle of claim 12, wherein the controller is further configured to transmit the notification to a customer corresponding with the refuse container including the contaminant, based on detecting the presence of the contaminant.

14. The refuse vehicle of claim 12, wherein the detection device comprises an electromagnetic imaging device, and wherein the controller is configured to:
receive electromagnetic scan data of the refuse material from the electromagnetic imaging device;
generate an electromagnetic image of the refuse material based on the electromagnetic scan data; and
determine the presence of a contaminant within the refuse material, based on the electromagnetic image and identifiers stored within a memory of the controller, the identifiers comprising an electromagnetic signal corresponding to a material of the contaminant within the refuse material.

15. The refuse vehicle of claim 12, wherein the detection device comprises a thermal imaging device, and wherein the controller is configured to:
receive thermal scan data of the refuse material from the thermal imaging device;
generate a thermal image of the refuse material based on the thermal scan data; and
determine the presence of the contaminant within the refuse material, based on the thermal image and identifiers stored within a memory of the controller, the identifiers comprising a thermal signature corresponding to a material of the contaminant within the refuse material.

16. The refuse vehicle of claim 15, wherein the contaminant detection system further comprises an agitator configured to agitate the refuse material within the refuse container.

17. The refuse vehicle of claim 16, wherein the controller is configured to:
generate a first thermal image of the refuse material based on a first thermal scan data from the thermal imaging device;
operate the agitator to agitate the refuse material within the refuse container;
generate a second thermal image of the refuse material based on a second thermal scan data from the thermal imaging device, the second thermal scan data received from the thermal imaging device after agitation of the refuse material; and
determine the presence of the contaminant within the refuse material, based on (i) comparing the first thermal image to the second thermal image and (ii) identifiers stored within a memory of the controller, the identifiers comprising a change in thermal signature corresponding to a material of the contaminant within the refuse material after agitation.

18. The refuse vehicle of claim 12, wherein the detection device is a metal detector configured to detect a trigger element corresponding to the contaminant.

19. A refuse vehicle, comprising:
a chassis;
a body coupled to the chassis;
a grabber assembly coupled to the body, the grabber assembly configured to engage a refuse container; and
a contaminant detection system, comprising:
a detection device coupled to the grabber assembly, the detection device configured to generate scan data indicative of refuse material contained within the refuse container;
an agitator coupled to the grabber assembly, the agitator configured to agitate the refuse material within the refuse container; and
a controller communicably coupled to the detection device, the controller comprising one or more processors communicably coupled to a memory, wherein the memory stores identifiers corresponding to a presence of a contaminant within the refuse material, and wherein the controller is configured to:
control the agitator to agitate the refuse material;
generate a scan of the refuse material based on the scan data; and
determine, based on the scan data and the identifiers, the presence of a contaminant within the refuse material.

20. The refuse vehicle of claim 19, wherein the detection device is a thermal camera, wherein the agitator is configured to heat the refuse material, and wherein the identifiers comprise a thermal signature corresponding to a material of the contaminant within the refuse material.
